(19) United States
(12) Patent Application Publication
(10) Pub. No.: US 2021/0063343 A1
(43) Pub. Date: Mar. 4, 2021

(54) SENSOR ELEMENT

(71) Applicant: NGK INSULATORS, LTD., Nagoya-shi (JP)

(72) Inventors: Yusuke WATANABE, Nagoya-shi (JP); Shotaro NIIZUMA, Kasugai-shi (JP)

(21) Appl. No.: 16/991,082

(22) Filed: Aug. 12, 2020

(30) Foreign Application Priority Data
Aug. 28, 2019 (JP) 2019-155840

(51) Int. Cl. G01N 27/406; G01N 27/409; G01N 27/41

(52) U.S. Cl. CPC G01N 27/4067; G01N 27/41; G01N 27/409

(57) ABSTRACT

A sensor element includes: a sensor electrode disposed on one main surface of a solid electrolyte layer to face a measurement gas introduction space, and having an oxygen decomposition ability and a NOx decomposition ability; a monitor electrode disposed on the one main surface of the solid electrolyte layer to face the measurement gas introduction space, and having the oxygen decomposition ability; and a reference electrode disposed on the other main surface of the solid electrolyte layer to face a reference gas introduction space, wherein a heater element of a heater part overlaps 50% or more of an area of each of the sensor electrode and the monitor electrode in plan view.

### CROSS-REFERENCE TO RELATED APPLICATION

The present application claims priority from Japanese application JP 2019-155840, filed on Aug. 28, 2019, the contents of which is hereby incorporated by reference into this application.

### BACKGROUND OF THE INVENTION

### Field of the Invention

The present invention relates to a gas sensor for determining concentration of nitrogen oxides (NOx), and, in particular, to arrangement of electrodes in a sensor element thereof.

### Description of the Background Art

As a gas sensor (NOx sensor) including a sensor element containing an oxygen-ion conductive solid electrolyte as a main component, a gas sensor that adjusts an oxygen concentration of a measurement gas using a pump cell, and then measures concentration of NOx in the measurement gas based on a value of a difference between a current flowing through a monitor cell for pumping only oxygen and a current flowing through a sensor cell for pumping oxygen and NOx has already been known (see Japanese Patent Application Laid-Open No. 2016-20894, for example).

In a case where a gas sensor as described above is installed on an exhaust path of a vehicle for use, it is desirable that the gas sensor can be used stably for a long time. On the other hand, the gas sensor is used in a state of a sensor element being heated to a high temperature for activation of a solid electrolyte, so that electrodes of the sensor element are deteriorated upon long-term exposure to the high temperature to affect a pumping ability of each cell. Thus, in a case of a gas sensor for determining the NOx concentration based on the value of the difference between a current value of the monitor cell and a current value of the sensor cell as disclosed in Japanese Patent Application Laid-Open No. 2016-20894, it is desirable that deterioration behaviors of electrodes of both cells be the same in terms of maintaining NOx sensing accuracy.

### SUMMARY

The present invention relates to a gas sensor for determining concentration of nitrogen oxides (NOx), and is, in particular, directed to arrangement of electrodes of a sensor element thereof.

According to the present invention, a sensor element for a gas sensor measuring concentration of NOx in a measurement gas includes: an oxygen-ion conductive solid electrolyte layer; a measurement gas introduction space into which the measurement gas is introduced; a reference gas introduction space into which a reference gas is introduced; a heater part to heat the sensor element; a sensor electrode disposed on one main surface of the solid electrolyte layer to face the measurement gas introduction space, and having an oxygen decomposition ability and a NOx decomposition ability; a monitor electrode disposed on the one main surface of the solid electrolyte layer to face the measurement gas introduction space, and having the oxygen decomposition ability; and a reference electrode disposed on the other main surface of the solid electrolyte layer to face the reference gas introduction space, wherein the sensor electrode, the reference electrode, and the solid electrolyte layer constitute a sensor cell as an electrochemical pump cell, the monitor electrode, the reference electrode, and the solid electrolyte layer constitute a monitor cell as an electrochemical pump cell, and, in plan view from a side of the one main surface, a heater element of the heater part overlaps 50% or more of an area of each of the sensor electrode and the monitor electrode.

Deterioration of the sensor element is thus limited to a degree allowable in actual use even in a case where the gas sensor is in continuous use.

It is thus an object of the present invention to provide a sensor element for a gas sensor enabling suppression of deterioration and securement of NOx measurement accuracy even when being in continuous use for a long time.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a vertical sectional view along a longitudinal direction in the vicinity of a leading end surface of a sensor element;

FIG. 2 is a sectional view perpendicular to the longitudinal direction in the vicinity of the leading end surface of the sensor element;

FIG. 3 illustrates planar arrangement of main components in the vicinity of a portion of a sensor element of Example 1 on a side of a leading end surface;

FIG. 4 illustrates planar arrangement of main components in the vicinity of a portion of a sensor element of Example 2 on a side of a leading end surface;

FIG. 5 illustrates planar arrangement of main components in the vicinity of a portion of a sensor element of Example 3 on a side of a leading end surface;

FIG. 6 illustrates planar arrangement of main components in the vicinity of a portion of a sensor element of Example 4 on a side of a leading end surface;

FIG. 7 illustrates planar arrangement of main components in the vicinity of a portion of a sensor element of Example 5 on a side of a leading end surface;

FIG. 8 illustrates planar arrangement of main components in the vicinity of a portion of a sensor element of Example 6 on a side of a leading end surface;

FIG. 9 illustrates planar arrangement of main components in the vicinity of a portion of a sensor element of Comparative Example 1 on a side of a leading end surface;

FIG. 10 illustrates planar arrangement of main components in the vicinity of a portion of a sensor element of Comparative Example 2 on a side of a leading end surface; and

FIG. 11 is a plot of NOx sensitivity change rates of gas sensors of Examples 1 to 6 and Comparative Examples 1 and 2 against an elapsed time of an accelerated durability test.

### DESCRIPTION OF THE PREFERRED EMBODIMENTS

<General Configuration of Gas Sensor>

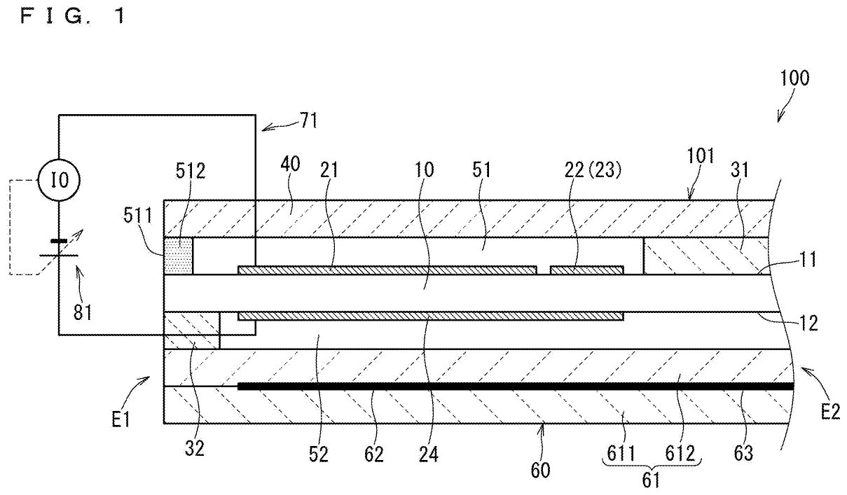

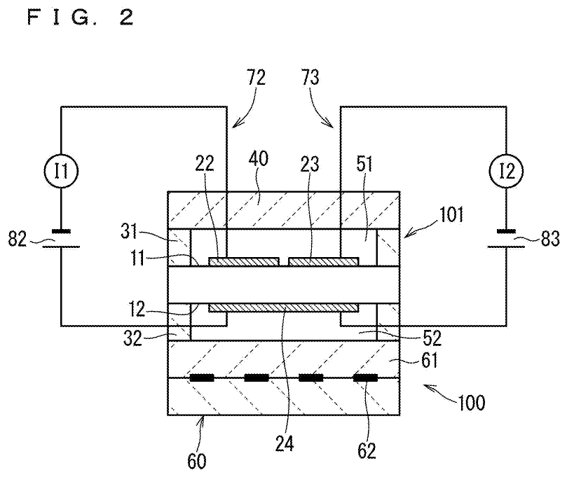

A general configuration of a gas sensor 100 including a sensor element 101 according to the present embodiment will be described first. In the present embodiment, the gas sensor 100 is a NOx sensor for sensing NOx and measuring concentration thereof using the sensor element 101. FIG. 1 is a vertical sectional view along a longitudinal direction in the vicinity of a leading end surface E1 of the sensor element 101. FIG. 2 is a sectional view perpendicular to the longitudinal direction in the vicinity of the leading end surface E1 of the sensor element 101. A surface opposite the leading end surface E1 along the longitudinal direction of the sensor element 101 (hereinafter, an element longitudinal direction) is referred to as a proximal end surface E2.

As illustrated in FIGS. 1 and 2, the sensor element 101 generally has a configuration in which an insulating spacer layer 31 and an insulating layer 40 are stacked on a side of one main surface 11 of a solid electrolyte layer 10, and an insulating spacer layer 32 and a heater part 60 are stacked on a side of the other main surface 12 of the solid electrolyte layer 10. The spacer layers 31 and 32 and the insulating layer 40 are made of alumina, for example.

The solid electrolyte layer 10 is a layer made of oxygen-ion conductive ceramic, such as zirconia (yttria stabilized zirconia).

In the vicinity of the leading end surface E1 of the sensor element 101, a space in which the spacer layer 31 is not disposed is present between the one main surface 11 of the solid electrolyte layer 10 and the insulating layer 40. The space is referred to as a measurement gas introduction space 51. A gas inlet 511 is provided in the spacer layer 31 to face the leading end surface E1, and a diffusion control part 512 formed of a porous body is buried between the gas inlet 511 and the measurement gas introduction space 51. The diffusion control part 512 provides predetermined diffusion resistance to a measurement gas introduced through the gas inlet 511 into the measurement gas introduction space 51.

On the one main surface 11 of the solid electrolyte layer 10, an oxygen pump electrode 21, a sensor electrode 22, and a monitor electrode 23 are disposed to face the measurement gas introduction space 51. As illustrated in FIG. 1, the oxygen pump electrode 21 is disposed at a location closer to the leading end surface E1 than the sensor electrode 22 and the monitor electrode 23 are in the measurement gas introduction space 51. The measurement gas introduced into the measurement gas introduction space 51 thereby reaches the sensor electrode 22 and the monitor electrode 23 after reaching the oxygen pump electrode 21.

On the other hand, the sensor electrode 22 and the monitor electrode 23 are arranged parallel with respect to the element longitudinal direction in a case illustrated in FIGS. 1 and 2, but this is just an example. The sensor electrode 22 and the monitor electrode 23 may be arranged in series.

The oxygen pump electrode 21 is made of a cermet of a Pt—Au alloy and zirconia, and has an oxygen decomposition ability. The Pt—Au alloy preferably has an Au content of 20 wt % or less.

The sensor electrode 22 is made of a cermet of a Pt—Rh alloy and zirconia, and has the oxygen decomposition ability and a NOx decomposition ability. The Pt—Rh alloy preferably has an Rh content of 80 wt % or less.

Furthermore, the monitor electrode 23 and a reference electrode 24 are made of a cermet of Pt and zirconia, and have the oxygen decomposition ability.

On the other hand, in a predetermined range from the proximal end surface E2 to the vicinity of the leading end surface E1 of the sensor element 101, a space in which the spacer layer 32 is not disposed is present between the other main surface 12 of the solid electrolyte layer 10 and the heater part 60. The space is referred to as a reference gas introduction space 52. Atmospheric air as a reference gas is introduced into the reference gas introduction space 52 from a side of the proximal end surface E2. The measurement gas introduction space 51 and the reference gas introduction space 52 are isolated from each other to prevent the measurement gas introduced into the former from being introduced into the latter.

On the other main surface 12 of the solid electrolyte layer 10, the reference electrode 24 is disposed to face the reference gas introduction space 52. That is to say, the reference electrode 24 is disposed to always be in contact with the atmospheric air as the reference gas.

Furthermore, in the gas sensor 100, an oxygen pump cell 71, a sensor cell 72, and a monitor cell 73 are constituted.

The oxygen pump cell 71 is an electrochemical pump cell constituted by the oxygen pump electrode 21, the reference electrode 24, and the solid electrolyte layer 10. In the oxygen pump cell 71, a voltage is applied between the oxygen pump electrode 21 and the reference electrode 24 by a variable power supply 81 disposed external to the sensor element 101. Oxygen in the measurement gas is decomposed by application of the voltage to allow an oxygen-ion current (oxygen pump current I0) to flow through the solid electrolyte layer 10. In the oxygen pump cell 71, the voltage applied by the variable power supply 81 is feedback controlled so that the oxygen pump current I0 has a magnitude having a value responsive to a desired value of an oxygen concentration in the measurement gas introduction space 51.

The sensor cell 72 is an electrochemical pump cell constituted by the sensor electrode 22, the reference electrode 24, and the solid electrolyte layer 10. In the sensor cell 72, a constant voltage is applied between the sensor electrode 22 and the reference electrode 24 by a power supply 82 disposed external to the sensor element 101. In the sensor cell 72, NOx in the measurement gas adjusted by the oxygen pump cell 71 to have the oxygen concentration of the desired value and a tiny amount of oxygen still remaining in the measurement gas adjusted above are decomposed by application of the voltage to allow an oxygen-ion current I1 to flow through the solid electrolyte layer 10.

On the other hand, the monitor cell 73 is an electrochemical pump cell constituted by the monitor electrode 23, the reference electrode 24, and the solid electrolyte layer 10. In the monitor cell 73, a constant voltage is applied between the monitor electrode 23 and the reference electrode 24 by a power supply 83 disposed external to the sensor element 101. In the monitor cell 73, a tiny amount of oxygen still remaining in the measurement gas adjusted by the oxygen pump cell 71 to have the oxygen concentration of the desired value is decomposed by application of the voltage to allow an oxygen-ion current I2 to flow through the solid electrolyte layer 10.

In the gas sensor 100, a NOx concentration is determined based on the correlation between the concentration of NOx in the measurement gas and a value of a difference between the oxygen-ion current I1 flowing through the sensor cell 72 and the oxygen-ion current I2 flowing through the monitor cell 73. The value of the difference is hereinafter also referred to as a NOx corresponding current value.

Arrangement of the oxygen pump electrode 21, the sensor electrode 22, the monitor electrode 23, and the reference electrode 24 illustrated in FIGS. 1 and 2 is just an example. Arrangement is not limited to this arrangement, and various arrangements can be used. In particular, as for the sensor electrode 22, the monitor electrode 23, and the reference electrode 24, various arrangements can be used as long as requirements described below are met.

The heater part 60 has a configuration in which a heater element 62 and a pair of heater leads 63 are sandwiched between a pair of insulating ceramic layers 61 (611, 612) stacked on a side of the other main surface 12 of the solid electrolyte layer 10. The heater element 62 and the pair of heater leads 63 are disposed symmetrically along an element width direction (a left-right direction in FIG. 2).

The heater element 62 is a resistance heating body disposed in a predetermined range in the vicinity of the leading end surface E1 of the sensor element 101. Opposite ends of the heater element 62 are connected to the pair of heater leads 63 as a current-carrying path disposed along the element longitudinal direction. The heater element 62 generates heat by being powered by a heater power supply, which is not illustrated, disposed external to the sensor element 101 through the heater leads 63.

The sensor element 101 is heated to a predetermined temperature (an element driving temperature) of 600° C. to 950° C. through heat generation of the heater element 62 for activation of the solid electrolyte layer 10, when being in use. The sensor element 101 is not necessarily required to be uniformly heated, and may be heated to have a temperature varied with location.

The heater element 62 is disposed symmetrically with respect to the element longitudinal direction and meanderingly to go and return along the element longitudinal direction between a portion connected to one of the heater leads 63 and a portion connected to the other one of the heater leads 63. In other words, the heater element 62 is disposed to have at least two turns on a side of the leading end surface E1 and at least one turn on the side of the proximal end surface E2. More particularly, in a case where there are n turns on the side of the proximal end surface E2, there are n+1 turns on the side of the leading end surface E1.

Each of the turns of the heater element 62 on the side of the leading end surface E1 and the side of the proximal end surface E2 may be arcuate or rectangular.

<Arrangement of Electrodes and Heater>

In the gas sensor 100 according to the present embodiment, the measurement gas having a temperature of approximately several hundred degrees Celsius is introduced into the measurement gas introduction space 51 provided in the sensor element 101, which is heated to the predetermined element driving temperature. And then, as described above, the concentration of NOx in the measurement gas is determined based on the NOx corresponding current value, which is the value of the difference between the oxygen-ion current I1 flowing through the sensor cell 72 and the oxygen-ion current I2 flowing through the monitor cell 73. In terms of securing measurement accuracy (NOx sensitivity) even in a case where the gas sensor 100 is in continuous use for a long time, it is preferable that the sensor electrode 22 of the sensor cell 72 and the monitor electrode 23 of the monitor cell 73 be heated on similar temperature conditions when the gas sensor 100 is in use to reduce a variation in thermoelectromotive force between them and an inter-cell IR drop.

Heating the sensor electrode 22 and the monitor electrode 23 in the same manner means that deterioration behaviors of the sensor electrode 22 and the monitor electrode 23 when the gas sensor 100 is in continuous use become approximately equal to each other. If the deterioration behaviors of both electrodes are equal to each other, measurement accuracy is likely to be kept over a relatively long time.

In the gas sensor 100 according to the present embodiment, in view of these points, planar arrangement of the sensor electrode 22, the monitor electrode 23, and the heater element 62 of the sensor element 101 at least meets a requirement (a) below, and further planar arrangement of them and the reference electrode 24 preferably meets at least one of requirements (b) to (e) below, so that deterioration thereof is limited to a degree allowable in use even in a case where the gas sensor 100 is in continuous use:

(a) The heater element 62 overlaps 50% or more of the area of each of the sensor electrode 22 and the monitor electrode 23;

(b) The heater element 62 overlaps 80% or more of the area of each of the sensor electrode 22 and the monitor electrode 23;

(c) Each of the sensor electrode 22 and the monitor electrode 23 has a region to overlap both of the heater element 62 and the reference electrode 24, and the reference electrode 24 overlaps 50% or more of the area of each of the sensor electrode 22 and the monitor electrode 23;

(d) The sensor electrode 22 and the monitor electrode 23 are disposed at locations closer to the proximal end surface E2 in a range of disposition of the heater element 62 along the element longitudinal direction; and

(e) The sensor electrode 22 and the monitor electrode 23 are disposed parallel with respect to the element longitudinal direction.

There can be various cases and variations of specific arrangement of the sensor electrode 22, the monitor electrode 23, and the heater element 62, and further the reference electrode 24 meeting the requirement (a) and further the requirements (b) to (e).

### EXAMPLES

Eight types of gas sensors 100 having different specific arrangements of the sensor electrode 22, the monitor electrode 23, the reference electrode 24, and the heater element 62 were manufactured.

More particularly, as examples, six types of gas sensors 100 (Examples 1 to 6) at least meeting the requirement (a) were manufactured. On the other hand, as comparative examples, two types of gas sensors 100 (Comparative Examples 1 and 2) failing to meet any of the requirements (a) to (e) were manufactured.

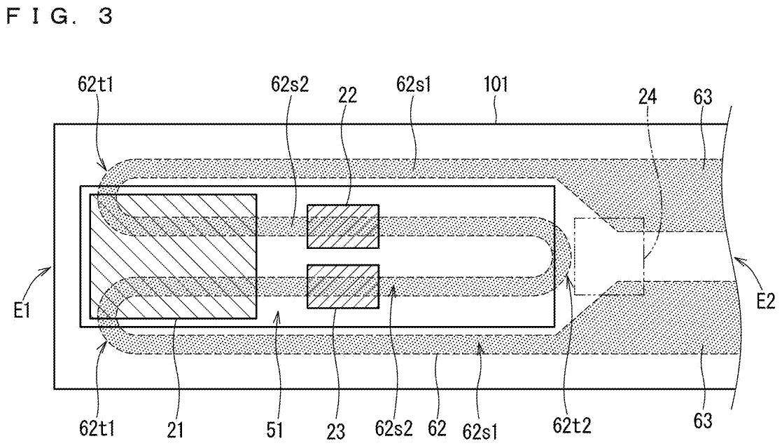

FIGS. 3 to 10 respectively illustrate planar arrangements of main components in the vicinity of the leading end surfaces E1 of sensor elements 101 of the gas sensors 100 of Examples 1 to 6 and Comparative Examples 1 and 2. More particularly, FIGS. 3 to 10 each illustrate arrangement in the vicinity of the leading end surface E1 of the sensor element 101 in plan view from the side of the one main surface 11 of the solid electrolyte layer 10.

Features of arrangements of the main components of the gas sensors 100 of Examples 1 to 6 and Comparative Examples 1 and 2 are shown in Table 1 as a list. Percentages (of the area) of overlaps of the heater element 62 and the reference electrode 24 with the sensor electrode 22 and the monitor electrode 23, results of determination (Determination 1) based on a NOx sensitivity change rate, and results of determination (Determination 2) based on a difference in thermoelectromotive force between the sensor cell 72 and the monitor cell 73 described below are shown in Table 2 as a list.

TABLE 1

| | | | SENSOR ELECTRODE | | | |
|---|---|---|---|---|---|---|
| | | | AND MONITOR ELECTRODE | | | |
| | | | | LOCATION ALONG | | |
| | HEATER | | | ELEMENT | | REFERENCE |
| | | NUMBER OF | | LONGITUDINAL | OVERLAP | ELECTRODE |
| | | TURNS ON | | DIRECTION | WITH | SHAPE ON |
| | SHAPE OF | PROXIMAL END | | RELATIVE TO | REFERENCE | PROXIMAL END |
| | TURN | PORTION SIDE | ARRANGEMENT | HEATER ELEMENT | ELECTRODE | PORTION SIDE |
| EXAMPLE 1 | ARCUATE | 1 | PARALLEL | INTERMEDIATE | NOT | RECTANGULAR |
| | | | | | OVERLAP | |
| EXAMPLE 2 | ARCUATE | 1 | PARALLEL | ON PROXIMAL END | NOT | RECTANGULAR |
| | | | | PORTION SIDE | OVERLAP | |
| EXAMPLE 3 | RECTANGULAR | 1 | PARALLEL | ON PROXIMAL END | OVERLAP | ARCUATE |
| | | | | PORTION SIDE | | |
| EXAMPLE 4 | RECTANGULAR | 1 | PARALLEL | ON PROXIMAL END | OVERLAP | RECTANGULAR |
| | | | | PORTION SIDE | | |
| EXAMPLE 5 | ARCUATE | 2 | PARALLEL | ON PROXIMAL END | OVERLAP | ARCUATE |
| | | | | PORTION SIDE | | |
| EXAMPLE 6 | ARCUATE | 1 | SERIES | INTERMEDIATE | NOT | RECTANGULAR |
| | | | | (SENSOR ELECTRODE | OVERLAP | |
| | | | | IS CLOSER TO | | |
| | | | | LEADING END) | | |
| COMPARATIVE | ARCUATE | 1 | PARALLEL | ON PROXIMAL END | NOT | RECTANGULAR |
| EXAMPLE 1 | | | | PORTION SIDE | OVERLAP | |
| COMPARATIVE | ARCUATE | 1 | PARALLEL | ON PROXIMAL END | NOT | RECTANGULAR |
| EXAMPLE 2 | | | | PORTION SIDE | OVERLAP | |

TABLE 2

| | SENSOR ELECTRODE AND MONITOR ELECTRODE | | | |
|---|---|---|---|---|
| | PERCENTAGE (%) OF | PERCENTAGE (%) OF | | |
| | OVERLAP WITH | OVERLAP WITH | | |
| | HEATER ELEMENT | REFERENCE ELECTRODE | DETERMINATION 1 | DETERMINATION 2 |
| EXAMPLE 1 | 50 | 0 | Δ | Δ |
| EXAMPLE 2 | 80 | 0 | ◯ | Δ |
| EXAMPLE 3 | 50 | 50 | ◯ | ◯ |
| EXAMPLE 4 | 80 | 80 | ◯ | ◯ |
| EXAMPLE 5 | 80 | 95 | ◯ | ◯ |
| EXAMPLE 6 | 50 | 0 | Δ | Δ |
| COMPARATIVE | 0 | 0 | X | X |
| EXAMPLE 1 | | | | |
| COMPARATIVE | 30 | 0 | X | X |
| EXAMPLE 2 | | | | |

### Example 1

In the sensor element 101 of Example 1, as illustrated in FIG. 3, the heater element 62 has two first turns 62t1 on the side of the leading end surface E1, one second turn 62t2 on the side of the proximal end surface E2, two first linear portions 62s1 extending along the element longitudinal direction between the first turns 62t1 and respective tapered ends of the pair of heater leads 63, and two second linear portions 62s2 extending along the element longitudinal direction between the respective first turns 62t1 and the second turn 62t2.

The first turns 62t1 and the second turn 62t2 are each arcuate. The first linear portions 62s1 are disposed outward along the element width direction, and the second linear portions 62s2 are disposed inward along the element width direction. All the linear portions are arranged at regular intervals along the element width direction. The measurement gas introduction space 51 is provided, along the element longitudinal direction, in a range from a location closer to the leading end surface E1 than the first turns 62t1 are to the second turn 62t2, and, along the element width direction, in a range sandwiched between the two first linear portions 62s1.

In the measurement gas introduction space 51, in plan view from the side of the one main surface 11 of the solid electrolyte layer 10, the sensor electrode 22 and the monitor electrode 23 are disposed parallel in shapes that a longitudinal direction of each of the electrodes matches the element longitudinal direction, at locations which are intermediate in a presence range of the heater element 62 along the element longitudinal direction and where those electrodes overlap the respective second linear portions 62s2 in plan view. That is to say, the sensor element 101 of Example 1 meets the requirement (e). The area of the overlap is 50% of the area of each of the sensor electrode 22 and the monitor electrode 23. That is to say, the sensor element 101 of Example 1 meets the requirement (a).

The oxygen pump electrode 21 is disposed closer to the leading end surface E1 than the sensor electrode 22 and the monitor electrode 23 in the measurement gas introduction space 51.

On the other hand, the reference electrode 24 is disposed to be rectangular in plan view at a location closer to the proximal end surface E2 than the second turn 62t2 is. That is to say, the reference electrode 24 does not overlap the sensor electrode 22 and the monitor electrode 23.

As described above, the sensor element 101 of Example 1 meets the requirements (a) and (e).

### Example 2

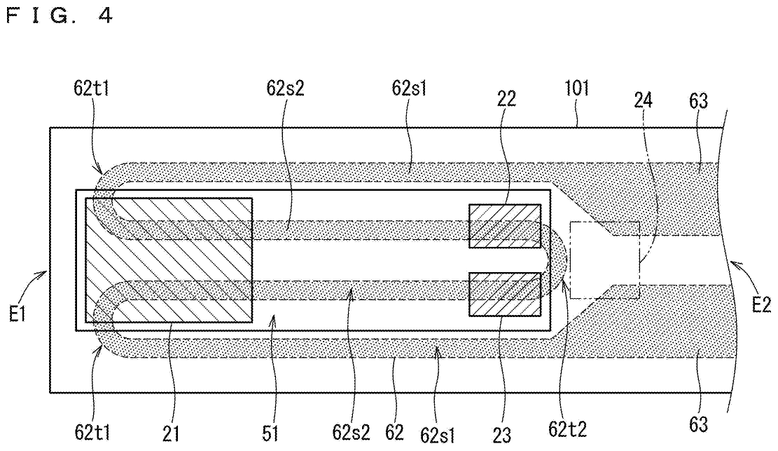

As illustrated in FIG. 4, the sensor element 101 of Example 2 has a similar configuration to that of Example 1 except that the sensor electrode 22 and the monitor electrode 23 are disposed closer to the proximal end surface E2 than those of Example 1 are to thereby be separated from the oxygen pump electrode 21 along the element longitudinal direction compared with those of Example 1. That is to say, the sensor element 101 of Example 2 meets the requirements (a), (d), and (e).

However, the area of the overlap of the sensor electrode 22 and the monitor electrode 23 with the heater element 62 is 80% of the area of each of the sensor electrode 22 and the monitor electrode 23. The sensor element 101 of Example 2 further meets the requirement (b).

As described above, the sensor element 101 of Example 2 meets the requirements (a), (b), (d), and (e).

### Example 3

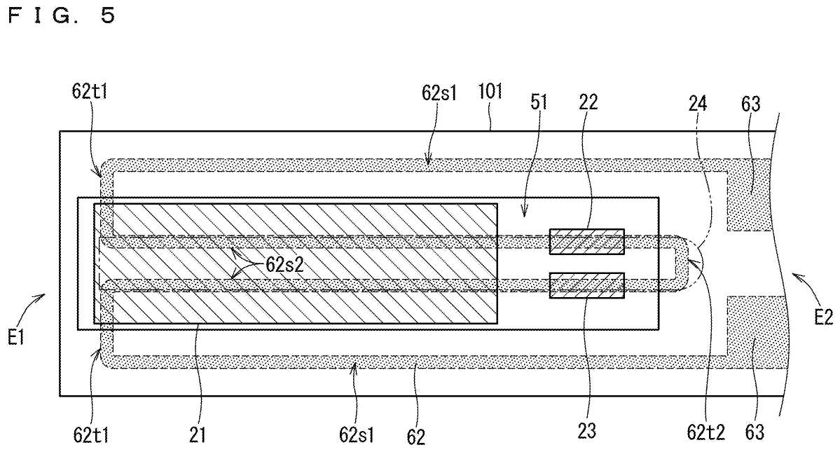

As illustrated in FIG. 5, as for the heater part 60, the sensor element 101 of Example 3 is the same as that of Example 1 in number and arrangement of the first turns 62t1, the second turn 62t2, the first linear portions 62s1, and the second linear portions 62s2 of the heater element 62, but is different from that of Example 1 in that the ends of the heater leads 63 connected to the respective first linear portions 62s1 are rectangular, the first turns 62t1 and the second turn 62t2 are rectangular, and the distance between the second linear portions 62s2 is shorter than the distance between the first linear portions 62s1 and the second linear portions 62s2.

The sensor electrode 22 and the monitor electrode 23 are disposed parallel as with those of Example 1 at locations closer to the proximal end surface E2 along the element longitudinal direction as with those of Example 2. That is to say, the sensor element 101 of Example 3 meets the requirements (d) and (e). However, the area of the overlap of the sensor electrode 22 and the monitor electrode 23 with the heater element 62 is only 50% of the area of each of the sensor electrode 22 and the monitor electrode 23. That is to say, the sensor element 101 of Example 3 meets the requirement (a). The oxygen pump electrode 21 extends to the side of the proximal end surface E2 compared with that of Example 2, and thus, a gap from the oxygen pump electrode 21 to the sensor electrode 22 and the monitor electrode 23 is approximately the same as that of Example 1. The reference electrode 24 is disposed, along the element longitudinal direction, in a range from the first turns 62t1 to the second turn 62t2, and, along the element width direction, in a range in which ends of the reference electrode 24 just overlap the pair of the second linear portions 62s2 as a whole. An end of the reference electrode 24 on the side of the proximal end surface E2 is arcuate.

The reference electrode 24 is thereby disposed to overlap the sensor electrode 22 and the monitor electrode 23 in plan view. The area of the overlap of the sensor electrode 22 and the monitor electrode 23 with the reference electrode 24 is 50% of the area of each of the sensor electrode 22 and the monitor electrode 23. That is to say, the sensor element 101 of Example 3 meets the requirement (c).

As described above, the sensor element 101 of Example 3 meets the requirements (a), (c), (d), and (e).

### Example 4

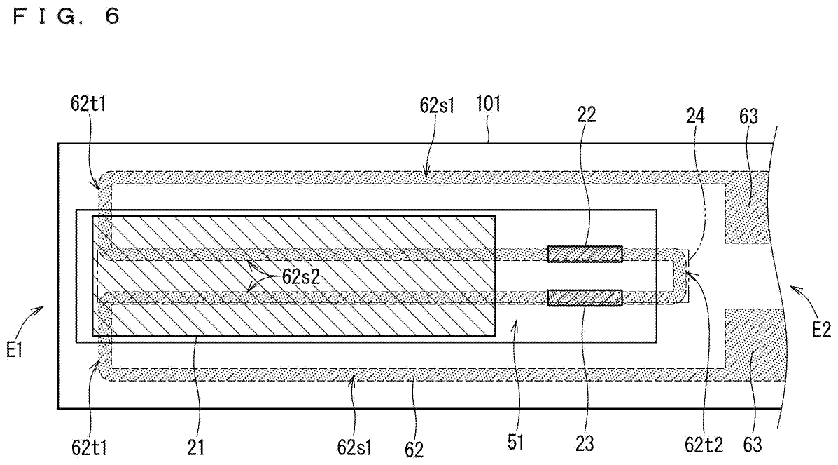

As illustrated in FIG. 6, the sensor element 101 of Example 4 has a similar configuration to that of the sensor element 101 of Example 3 except that the size of each of the sensor electrode 22 and the monitor electrode 23 along the element width direction is reduced. More specifically, the sensor electrode 22 and the monitor electrode 23 are disposed so that the area of the overlap with the heater element 62 and the area of the overlap with the reference electrode 24 are each 80% of the area of each of the sensor electrode 22 and the monitor electrode 23.

Accordingly, the sensor element 101 of Example 4 thus meets the requirements (a) to (e).

### Example 5

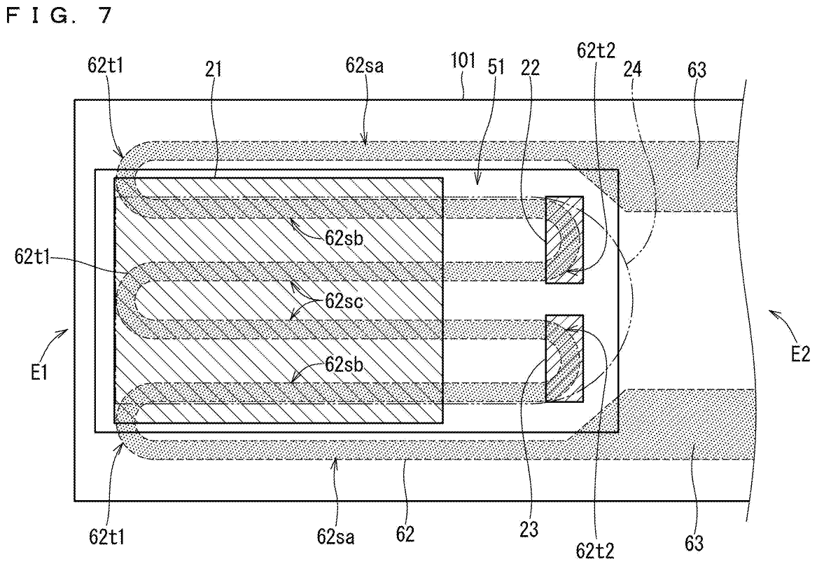

In the sensor element 101 of Example 5, as illustrated in FIG. 7, the heater element 62 has three first turns 62t1 on the side of the leading end surface E1, two second turns 62t2 on the side of the proximal end surface E2, two first linear portions 62sa extending along the element longitudinal direction between first turns 62t1 disposed outward along the element width direction and respective tapered ends of the pair of heater leads 63, two second linear portions 62sb extending along the element longitudinal direction between the first turns 62t1 disposed outward along the element width direction and the second turns 62t2, and two third linear portions 62sc extending along the element longitudinal direction between a first turn 62t1 disposed inward along the element width direction and the second turns 62t2. All the linear portions are arranged at regular intervals along the element width direction.

The first turns 62t1 and the second turns 62t2 are each arcuate.

The measurement gas introduction space 51 is provided, along the element longitudinal direction, in a range from a location closer to the leading end surface E1 than the first turns 62t1 to a location closer to the proximal end surface E2 than the second turns 62t2 are, and, along the element width direction, in a range sandwiched between the two first linear portions 62sa.

In the measurement gas introduction space 51, the sensor electrode 22 and the monitor electrode 23 are disposed parallel in shapes that the element width direction matches the longitudinal direction of each of the electrodes, at locations where the sensor electrode 22 and the monitor electrode 23 overlap the respective second turns 62t2 in plan view. That is to say, the sensor element 101 of Example 5 meets the requirements (d) and (e). The area of the overlap is 80% of the area of each of the sensor electrode 22 and the monitor electrode 23. That is to say, the sensor element 101 of Example 5 meets the requirements (a) and (b).

On the other hand, the reference electrode 24 is disposed, along the element longitudinal direction, in a range from the first turns 62t1 to a location closer to the proximal end surface E2 than the second turns 62t2 are, and, along the element width direction, in a range in which the ends of the reference electrode 24 just overlap the pair of the second linear portions 62sb as a whole. The reference electrode 24 is thereby disposed to overlap the sensor electrode 22 and the monitor electrode 23 in plan view. The area of the overlap of the sensor electrode 22 and the monitor electrode 23 with the reference electrode 24 is 95% of the area of each of the sensor electrode 22 and the monitor electrode 23. That is to say, the sensor element 101 of Example 5 meets the requirement (c). The end of the reference electrode 24 on the side of the proximal end surface E2 is arcuate.

Accordingly, the sensor element 101 of Example 5 thus meets all the requirements (a) to (e).

### Example 6

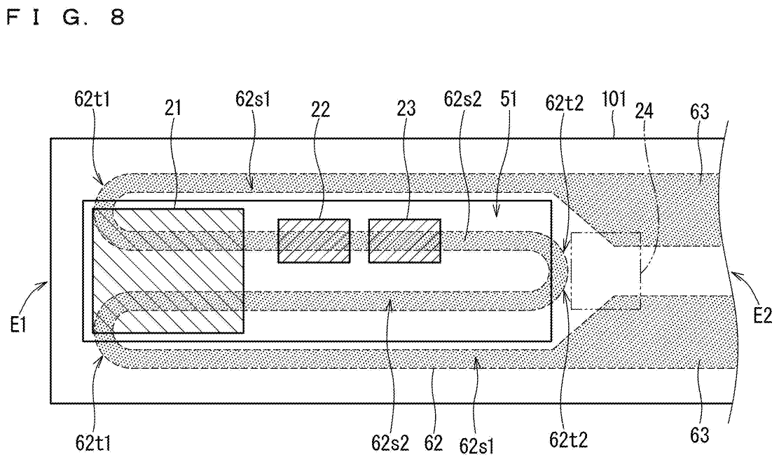

As illustrated in FIG. 8, the sensor element 101 of Example 6 has a similar configuration to that of the sensor element 101 of Example 1 except that the sensor electrode 22 and the monitor electrode 23 are disposed in series along the element longitudinal direction at intermediate locations in a presence range of the heater element 62 along the element longitudinal direction above one of the second linear portions 62s2. More specifically, the sensor electrode 22 and the monitor electrode 23 are disposed so that the area of the overlap with the heater element 62 is 50% of the area of each of the sensor electrode 22 and the monitor electrode 23.

Accordingly, the sensor element 101 of Example 6 thus meets the requirement (a).

### Comparative Example 1

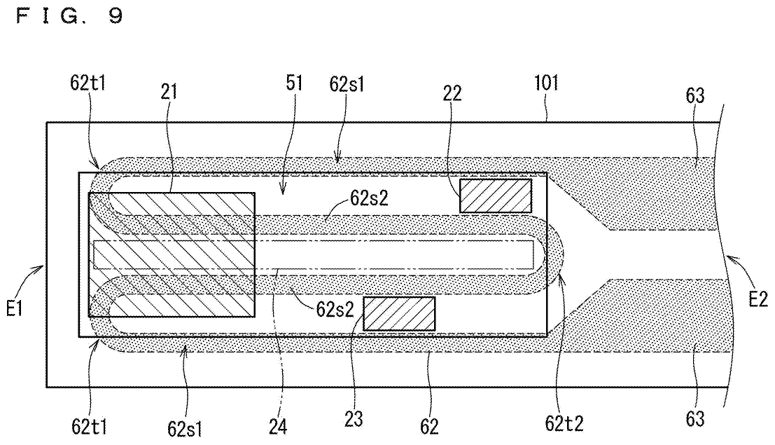

In the sensor element 101 of Comparative Example 1, as illustrated in FIG. 9, arrangement of the heater element 62 and the heater leads 63, the measurement gas introduction space 51, and the oxygen pump electrode 21 is similar to that of Example 1, but the sensor electrode 22 is disposed between one of the first linear portions 62s1 and one of the second linear portions 62s2, and the monitor electrode 23 is disposed between the other one of the first linear portions 62s1 and the other one of the second linear portions 62s2. Furthermore, the electrodes are disposed at different locations along the element longitudinal direction so that the monitor electrode 23 is disposed closer to the leading end surface E1 than the sensor electrode 22 is. The reference electrode 24 is disposed to be rectangular at a location between the two second linear portions 62s2.

Accordingly, the sensor element 101 of Comparative Example 1 thus fails to meet any of the requirements (a) to (e).

### Comparative Example 2

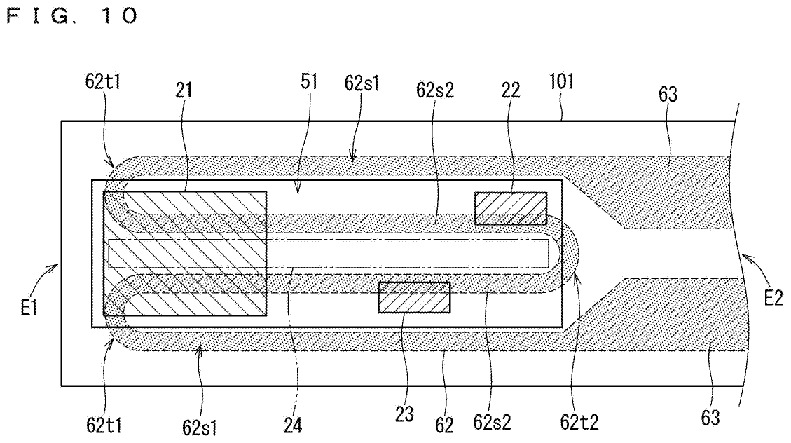

As illustrated in FIG. 10, the sensor element 101 of Comparative Example 2 has a similar configuration to that of the sensor element 101 of Comparative Example 1 except that the sensor electrode 22 and the monitor electrode 23 are disposed to overlap the second linear portions 62s2 of the heater element 62. More specifically, the area of the overlap of the sensor electrode 22 and the monitor electrode 23 with the second linear portions 62s2 is 30% of the area of each of the sensor electrode 22 and the monitor electrode 23.

Accordingly, the sensor element 101 of Comparative Example 2 thus fails to meet any of the requirements (a) to (e).

(Accelerated Durability Test)

An accelerated durability test was conducted on the sensor elements 101 of Examples 1 to 6 and Comparative Examples 1 and 2 having configurations as described above, and NOx sensitivity change rates before and after the test were evaluated. The accelerated durability test is intended as a test to evaluate the degree of deterioration over time.

The accelerated durability test was conducted under conditions below: Each of the gas sensors 100 was installed onto an exhaust pipe of an engine, and a 40-minute driving pattern configured to have an engine speed in a range of 1500 rpm to 3500 rpm and a load torque in a range of 0 N·m to 350 N·m was repeated until 1000 hours had elapsed. In this case, the element driving temperature was set to 800° C., temperature of the gas was maintained within a range of 200° C. to 600° C., and the NOx concentration was kept a value within a range of 0 ppm to 1500 ppm.

(Determination of NOx Sensitivity Change)

The NOx corresponding current value was determined through NOx measurement using a model gas having a NOx concentration of 500 ppm and an oxygen concentration of 0%, and containing nitrogen as the balance before the start, at 500 hours after the start, and at the end (at 1000 hours after the start) of the accelerated durability test.

Then, change rates of NOx sensitivity (NOx sensitivity change rate) in the respective timings were calculated from the respective NOx corresponding current values determined by measurement using, as a reference (an initial value), the value before the start of the test, and, based on the calculated value, the degree of a change in NOx sensitivity of each of the gas sensors 100 was determined (Determination 1).

In Determination 1, in a case where (the absolute value of) the NOx sensitivity change rate is 10% or less, it is determined that the change in NOx sensitivity is suitably suppressed, and a circle is marked in Table 2.

In a case where (the absolute value of) the NOx sensitivity change rate is more than 10% and 20% or less, it is determined that the change in NOx sensitivity is suppressed within a range allowable in actual use of the gas sensor 100, and a triangle is marked in Table 2.

On the other hand, as for each of the gas sensors 100 having a NOx sensitivity change rate of more than 20% and thus not corresponding to any of the above-mentioned cases, a cross is marked in Table 2.

(Determination of Difference in Thermoelectromotive Force)

As for each of the sensor elements 101 of Examples 1 to 6 and Comparative Examples 1 and 2 after the accelerated durability test, a thermoelectromotive force in each of the sensor cell 72 and the monitor cell 73 was measured in an ambient atmosphere. The element driving temperature was set to 800° C. A value of a difference in thermoelectromotive force (thermoelectromotive force difference) between them was determined, and, based on the value, the degree of a difference in deterioration between the sensor electrode 22 and the monitor electrode 23 was determined (Determination 2).

In Determination 2, in a case where (the absolute value of) the thermoelectromotive force difference is 5 mV or less, it is determined that a significant difference in degree of deterioration between the sensor electrode 22 and the monitor electrode 23 is not caused, and a circle is marked in Table 2.

In a case where (the absolute value of) the thermoelectromotive force difference is more than 5 mV and 10 mV or less, it is determined that the difference in deterioration between the sensor electrode 22 and the monitor electrode 23 is within a range allowable in actual use of the gas sensor 100, and a triangle is marked in Table 2.

On the other hand, as for each of the gas sensors 100 having (the absolute value of) the thermoelectromotive force difference of more than 10 mV and thus not corresponding to any of the above-mentioned cases, a cross is marked in Table 2.

(Summary of Results of Determination)

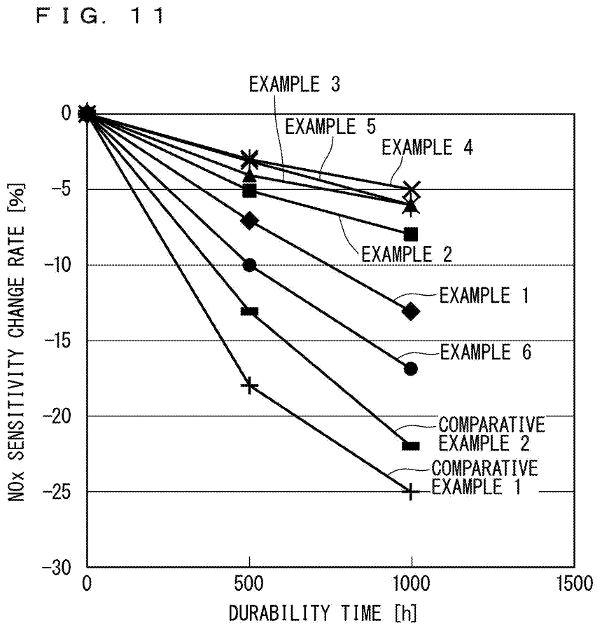

FIG. 11 is a plot of the NOx sensitivity change rates of the gas sensors 100 of Examples 1 to 6 and Comparative Examples 1 and 2 against an elapsed time of the accelerated durability test.

As shown in FIG. 11, as for each of the gas sensors 100, (the absolute value of) the NOx sensitivity change rate changed monotonically as the elapsed time of the accelerated durability test increased. On the other hand, it was found that (the absolute value of) the NOx sensitivity change rate of each of the gas sensors 100 of Examples 1 to 6 remained within 20% whereas (the absolute value of) the NOx sensitivity change rate of each of the gas sensors 100 of Comparative Examples 1 and 2 exceeded 20% after the elapse of 1000 hours.

More specifically, as for each of Examples 2 to 5, the NOx sensitivity change rate after the elapse of 1000 hours was 10% or less as shown by the circle marked in a column “DETERMINATION 1” in Table 2, and it was determined that the change in NOx sensitivity was suitably suppressed. In addition, the thermoelectromotive force difference between the sensor cell 72 and the monitor cell 73 was 5 mV or less as shown by the circle marked in a column “DETERMINATION 2” in Table 2, and it was determined that the significant difference in degree of deterioration between the sensor electrode 22 and the monitor electrode 23 was not caused.

As for each of Examples 1 and 6, the NOx sensitivity change rate after the elapse of 1000 hours was more than 10% and 20% or less as shown by the triangle marked in the column “DETERMINATION 1” in Table 2, and it was determined that the change in NOx sensitivity was suppressed within the range allowable in actual use of the gas sensor 100. In addition, the thermoelectromotive force difference between the sensor cell 72 and the monitor cell 73 was more than 5 mV and 10 mV or less as shown by the triangle marked in the column “DETERMINATION 2” in Table 2, and it was determined that the difference in deterioration between the sensor electrode 22 and the monitor electrode 23 was within the range allowable in actual use of the gas sensor 100.

On the other hand, as for each of Comparative Examples 1 and 2, the NOx sensitivity change rate after the elapse of 1000 hours was more than 20% as shown by the cross marked in the column “DETERMINATION 1” in Table 2. In addition, the thermoelectromotive force difference between the sensor cell 72 and the monitor cell 73 was more than 20 mV as shown by the cross marked in the column “DETERMINATION 2” in Table 2.

The above-mentioned results indicate that, as for the gas sensor 100 at least meeting the requirement (a), the change in NOx sensitivity and the difference in deterioration between the sensor electrode 22 and the monitor electrode 23 are suppressed within the range allowable in actual use of the gas sensor 100 even when the gas sensor 100 is used for a long time.

In particular, the results of Examples 2 to 5 indicate that, in the gas sensor 100 meeting at least one of the requirements (b) and (c) and meeting the requirements (d) and (e) in addition to the requirement (a), the change in NOx sensitivity is suitably suppressed, and the significant difference in degree of deterioration between the sensor electrode 22 and the monitor electrode 23 is not caused.

While the invention has been shown and described in detail, the foregoing description is in all aspects illustrative and not restrictive. It is therefore understood that numerous modifications and variations can be devised without departing from the scope of the invention.

What is claimed is:

1. A sensor element for a gas sensor measuring concentration of NOx in a measurement gas, said sensor element comprising:
an oxygen-ion conductive solid electrolyte layer;
a measurement gas introduction space into which said measurement gas is introduced;
a reference gas introduction space into which a reference gas is introduced;
a heater part to heat said sensor element;
a sensor electrode disposed on one main surface of said solid electrolyte layer to face said measurement gas introduction space, and having an oxygen decomposition ability and a NOx decomposition ability;
a monitor electrode disposed on said one main surface of said solid electrolyte layer to face said measurement gas introduction space, and having the oxygen decomposition ability; and
a reference electrode disposed on the other main surface of said solid electrolyte layer to face said reference gas introduction space, wherein
said sensor electrode, said reference electrode, and said solid electrolyte layer constitute a sensor cell as an electrochemical pump cell,
said monitor electrode, said reference electrode, and said solid electrolyte layer constitute a monitor cell as an electrochemical pump cell, and
in plan view from a side of said one main surface, a heater element of said heater part overlaps 50% or more of an area of each of said sensor electrode and said monitor electrode.

2. The sensor element according to claim 1, wherein
in plan view from the side of said one main surface, said heater element of said heater part overlaps 80% or more of the area of each of said sensor electrode and said monitor electrode.

3. The sensor element according to claim 1, wherein
in plan view from the side of said one main surface, each of said sensor electrode and said monitor electrode has a region to overlap both of said heater element and said reference electrode, and said reference electrode overlaps 50% or more of the area of each of said sensor electrode and said monitor electrode.

4. The sensor element according to claim 1, wherein
said sensor electrode and said monitor electrode are disposed at locations closer to a proximal end surface in a range of disposition of said heater element along an element longitudinal direction.

5. The sensor element according to claim 1, wherein
said sensor electrode and said monitor electrode are disposed parallel with respect to an element longitudinal direction.

6. The sensor element according to claim 2, wherein
said sensor electrode and said monitor electrode are disposed parallel with respect to an element longitudinal direction.

7. The sensor element according to claim 3, wherein
said sensor electrode and said monitor electrode are disposed parallel with respect to an element longitudinal direction.

8. The sensor element according to claim 4, wherein
said sensor electrode and said monitor electrode are disposed parallel with respect to the element longitudinal direction.
